(19) United States
(12) Patent Application Publication
(10) Pub. No.: US 2011/0038747 A1
(43) Pub. Date: Feb. 17, 2011

(54) AUTOMATIC VOLUME RATIO VARIATION FOR A ROTARY SCREW COMPRESSOR

(75) Inventor: Stephen L. Shoulders, Baldwinsville, NY (US)

Correspondence Address: Cantor Colburn LLP - Carrier, 20 Church Street, 22nd Floor, Hartford, CT, 06103, US

(73) Assignee: Carrier Corporation, Farmington, CT (US)

(21) Appl. No.: 12/989,282

(22) PCT Filed: Jun. 23, 2009
(86) PCT No.: PCT/US09/03721

§ 371 Date: Oct. 22, 2010

Related U.S. Application Data
(60) Provisional application No. 61/132,928, filed on Jun. 24, 2008.

(51) Int. Cl. F04C 18/08; F16K 15/14

(52) U.S. Cl. 418/201.2; 137/855

(57) ABSTRACT

A valve for varying volume ratio in a screw compressor to balance a compression pocket pressure and a discharge pressure in the screw compressor comprises a valve body and a reed valve. The valve body defines a duct and an auxiliary port. The duct includes an open end in communication with a discharge chamber of the compressor and thereby the discharge pressure. The auxiliary port extends from a rotor bore of the compressor to the duct and provides fluid communication therebetween for communicating the compression pocket pressure to the duct. The reed valve is disposed within the duct for regulating fluid flow between the compression pocket and the duct. The reed valve is operable via a pressure differential between the compression pocket pressure and the discharge pressure.

### FIELD OF THE INVENTION

This invention relates generally to screw compressors and more particularly to screw compressors with means for varying volume ratio.

### BACKGROUND

Screw-type compressors are commonly used in refrigeration and air conditioning systems. Interlocking male and female rotors, located in parallel intersecting bores, define compression pockets between meshed rotor lobes. Compressors with two rotors are most common, but other configurations having three or more rotors situated so as to act in pairs are known in the art. Fluid enters a suction port near one axial end of the rotor pair and exits near the opposite end through a discharge chamber. Suction and discharge ports may be located radially or axially with respect to the rotors. Initially, the compression pocket is in communication with the suction port. As the rotors turn, the compression pocket rotates past the suction port and becomes sealed between the male and female rotor lobes and the solid wall of the rotor bore. The enclosed pocket becomes smaller as it is translated axially downstream, compressing the fluid within. Finally, the compression pocket rotates into communication with the discharge chamber and the compressed fluid exits.

Volume V_{b} is defined as the pocket volume at the instant the enclosed pocket first loses communication with the suction port, trapping fluid at pressure P_{b}. Volume V_{f} is defined as the pocket volume just before the enclosed pocket first comes into communication with the discharge port and contains compressed fluid at pressure P_{f}. Compressor volume ratio (Vᵢ) is defined by the ratio of V_{b}/V_{f}. It is well known that volume ratio is an important feature of screw compressor design and operation. Its relevance to screw compressor design is described in references such as Industrial Compressors: Theory and Equipment (Peter A. O'Neill, author; Butterworth Heinemann, publisher; 1993; ISBN 0750608706; pages 306-309) and 1996 ASHRAE Systems and Equipment Handbook (Robert A. Parsons, editor; American Society of Heating, Refrigerating and Air-Conditioning Engineers, Inc., publisher; 1996; ISBN 1-883413-34-6; pages 34.18-34.19). As is known, compressor discharge pressure P_{d} is determined by system operating conditions, while, pressure P_{f} in compression pocket just before it comes into communication with discharge port is determined by volume ratio Vᵢ in combination with pressure P_{b} of gas in pocket volume V_{b}.

It is known that compression efficiency is optimum when P_{f} is equal to P_{d}. If P_{f} is less than P_{d}, the pocket fluid is under-compressed and discharge chamber fluid rushes into the pocket when they come into communication. If P_{f} is greater than P_{d}, the pocket fluid is over-compressed and the compressed fluid rushes out of the pocket into the discharge chamber when pocket and discharge chamber come into communication. Both under-compression and over-compression are known to be inefficient. Compressor vibration and fluid pulsation amplitudes are also higher when under-compression and over-compression occur, resulting in higher levels of undesirable sound.

Compressors that have a single built-in volume ratio will only operate without over-compression and under-compression at some operating conditions, not all. In these cases, the volume ratio is typically chosen to be optimum for a condition where compressor efficiency and sound levels are rated per industry standards. However, systems that use screw compressors, such as refrigeration systems, typically must operate over a wide range of conditions. For such systems, high energy efficiency and low sound levels are often important qualities. Considerable inventive effort has therefore been dedicated to developing systems with variable volume ratio so that over-compression and under-compression can be avoided, or at least diminished, at more operating conditions.

Prior art methods of achieving variable volume ratio control include: the use of an axially movable slide valve and sensing and actuating means, as exemplified in U.S. Pat. Nos. 3,088,659, 3,936,239, Re. 29,283, 4,362,472, 4,842,501, 5,018,948 and 5,411,387; the use of an axially movable slide valve and slide stop and sensing and actuating means in combination, as exemplified in U.S. Pat. Nos. 4,516,914 and 4,678,406; the use of radial lift valves and sensing and actuating means, as exemplified in U.S. Pat. Nos. 4,737,082, 4,878,818, 5,108,269 and 3,151,806 and 5,044,909; the use of lift valves in discharge end wall with sensing and actuating means, as exemplified in U.S. Pat. No. 4,946,362; the use of pressure-actuated lift valves in discharge end wall, either self-acting or with sensing and actuating means, as exemplified in U.S. Pat. Nos. 2,519,913 and 5,052,901 and European Patent 0175354; the use of a discharge end wall slide valve and sensing and actuating means as exemplified in U.S. Pat. No. 4,457,681. Other prior art means of achieving some degree of variable volume ratio control include those exemplified in U.S. Pat. Nos. 4,234,296 and 4,455,131.

In addition to differences of geometric form, these prior art methods can be distinguished by whether the variable volume control valve mechanism is actively controlled or self-acting. In actively controlled mechanisms, complicated sensing and actuating means are required to actuate the valve. In self-acting mechanisms, the valves are actuated directly by differential action of pressures P_{f} and P_{d}. In the latter case, achieving some volume ratio variation without the need of independent sensing and actuating means such as sensors, control logic, actuating lines and servo or solenoid control valves is desirable, considering cost.

### SUMMARY

A valve for varying volume ratio in a screw compressor to balance a compression pocket pressure and a discharge pressure in the screw compressor comprises a valve body and a reed valve. The valve body defines a duct and an auxiliary port. The duct includes an open end in communication with a discharge chamber of the compressor and thereby the discharge pressure. The auxiliary port extends from a rotor bore of the compressor to the duct and provides fluid communication therebetween for communicating the compression pocket pressure to the duct. The reed valve is disposed within the duct for regulating fluid flow between the compression pocket and the duct. The reed valve is operable via a pressure differential between the compression pocket pressure and the discharge pressure.

### BRIEF DESCRIPTION OF THE DRAWINGS

FIG. 1 is a perspective cutaway view of a rotary screw compressor in which an automatic variable volume ratio valve of the present invention is used.

FIG. 2 is a side sectional view of the screw compressor of FIG. 1 showing an automatic variable volume ratio valve.

FIG. 3 is a front sectional view of the screw compressor of FIG. 1 showing an automatic variable volume ratio valve positioned between mating screw rotors.

FIG. 4A is a top view of a rotor housing having the automatic variable volume ratio valve of FIGS. 2 and 3.

FIG. 4B is a perspective view of a multi-fingered reed valve for use in the automatic variable volume ratio valve of FIG. 4A.

FIG. 5A shows an end view of the automatic variable volume ratio valve of FIG. 3 in which fingers of reed valves are closed.

FIG. 5B shows an end view of the automatic variable volume ratio valve of FIG. 5B in which the fingers of the reed valves are open.

FIGS. 6A-6D illustrate decreasing compression pocket volume as screw rotors translate a compression pocket past radial auxiliary ports of the automatic variable volume ratio valve.

FIG. 7 is a side sectional view of a screw compressor having a slide valve including an automatic variable volume ratio valve of the present invention.

FIG. 8 is a front cross sectional view of the screw compressor of FIG. 7 showing the slide valve including an automatic variable volume ratio valve positioned between mating screw rotors.

### DETAILED DESCRIPTION

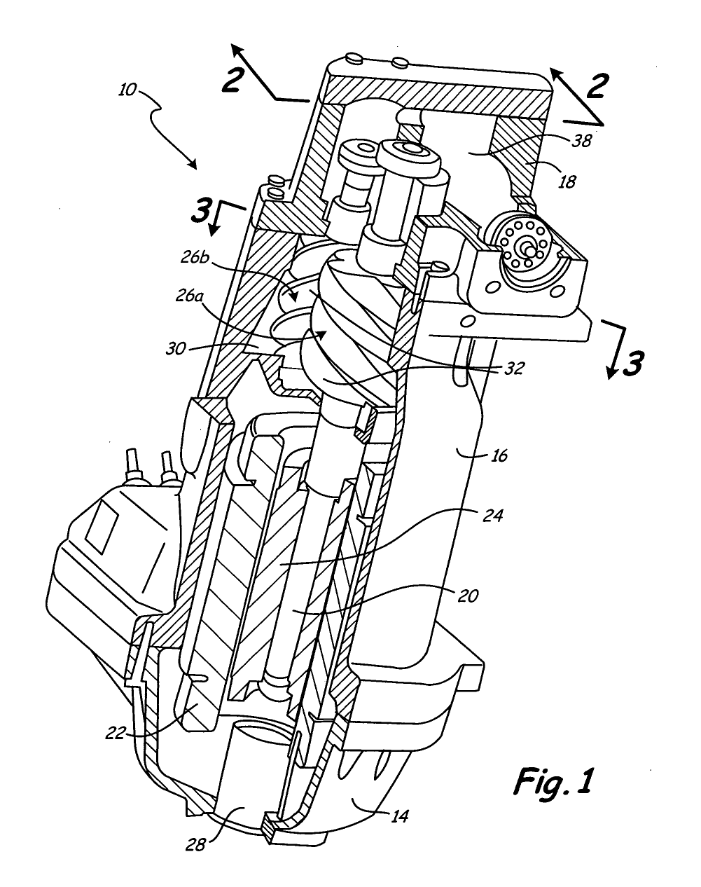

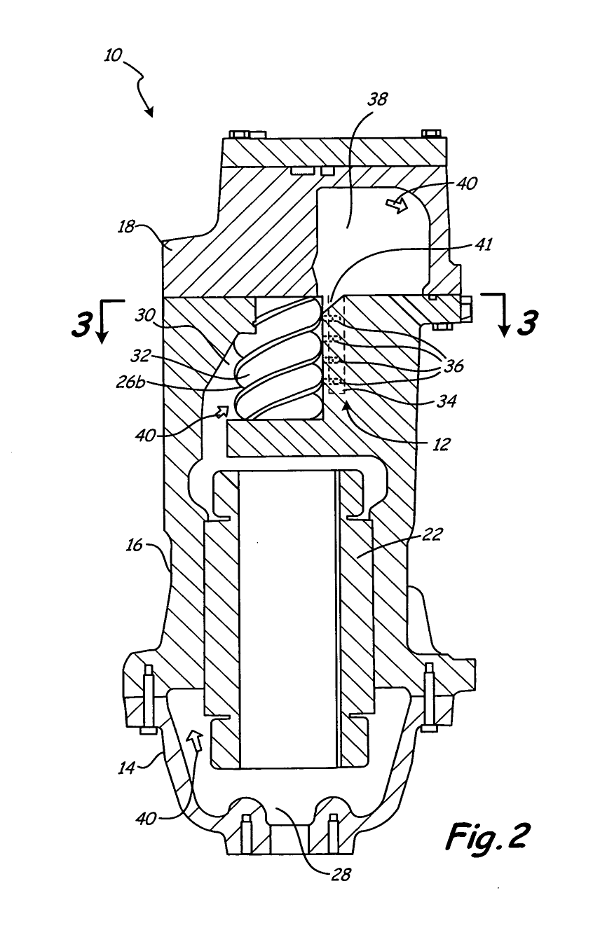

FIG. 1 is a perspective cutaway view of rotary screw compressor 10 in which an automatic variable volume ratio valve of the present invention is used. FIG. 2, which is discussed concurrently with FIG. 1, is a side sectional view of screw compressor 10 taken at section 2-2 of FIG. 1 showing automatic variable volume ratio valve 12 in hidden lines. Compressor 10 includes motor case 14, rotor case 16, outlet case 18, rotor shaft 20, motor stator 22, motor rotor 24, male screw rotor 26a and female screw rotor 26b. In FIG. 1, motor case 14, rotor case 16, outlet case 18, stator 22 and rotor 24 are partially cut-away to show shaft 20 and rotors 26a and 26b. In FIG. 2, compressor 10 is sectioned at approximately the cusp between rotors 26a and 26b, and rotor shaft 20, motor rotor 24 and male screw rotor 26a are not shown for clarity. Motor case 14 includes intake port 28, and rotor case 16 includes automatic variable volume ratio valve 12 and rotor bores 30, in which rotors 26a and 26b rotate. Rotors 26a and 26b include screw rotor lobes 32, and valve 12 includes pressure port or duct 34 and radial auxiliary ports 36. Outlet case 18 includes discharge chamber 38. Motor case 14 and outlet case 18 are fastened to rotor case 16 to form a housing in which shaft 20, stator 22, rotor 24 and screw rotors 26a and 26b are sealed such that a working fluid or gas, such as from a refrigerant, can be conducted between intake port 28 and discharge chamber 38.

As shown in FIG. 2, working fluid 40 at low pressure enters screw compressor 10 at intake port 28, travels through motor case 14 and rotor case 16 and into rotor bores 30. Within rotor bores 30, low pressure working fluid 40 enters a compression pocket adjacent rotor 26b and rotor 26a (FIG. 1) formed between screw rotor lobes 32 and walls of screw rotor bores 30. Motor rotor 24 rotates male screw rotor 26a (FIG. 1) and, by virtue of geared engagement, female screw rotor 26b, reducing the volume of the compression pocket and compressing fluid 40 as the pocket translates towards outlet case 18 between lobes 32. High pressure working fluid 40 is discharged from the pressure pocket into discharge chamber 38 through discharge port 41. Discharge chamber 38 is in open communication with high pressure fluid 40 and the system discharge pressure in which compressor 10 is used. Therefore, pressure in discharge chamber 38 reflects changes in the operation of compressor 10. Automatic variable volume ratio valve 12 of the present invention optimizes compression efficiency by balancing the pressure in the discharge pocket just before it comes into communication with discharge chamber 38 and the pressure in discharge chamber 38 over a range of operating conditions for compressor 10.

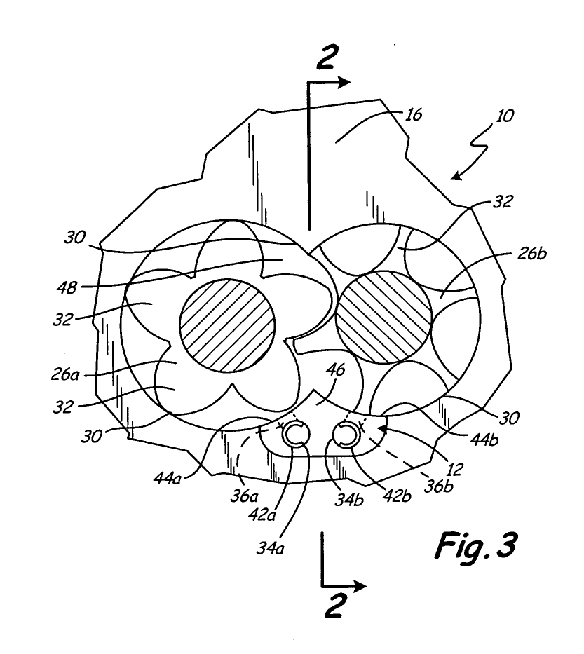

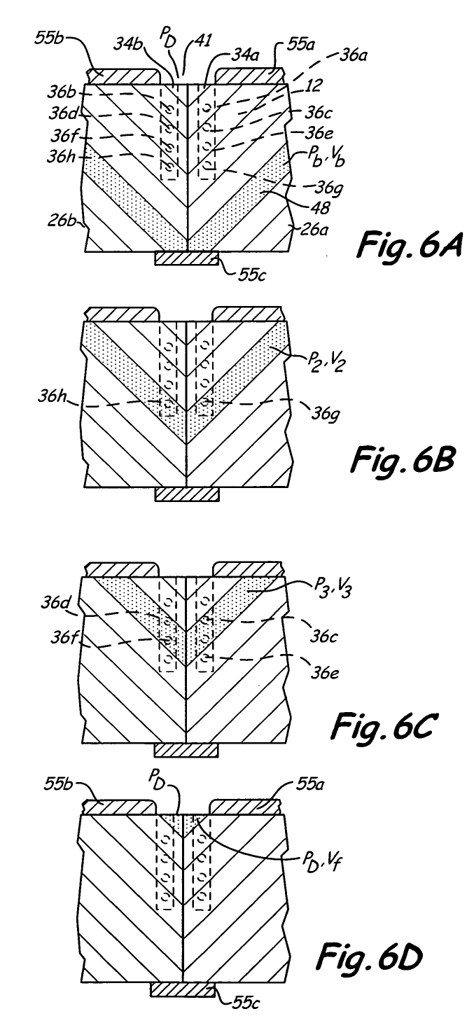

FIG. 3 is a front sectional view of screw compressor 10 taken at section 3-3 of FIG. 1 showing a front surface of rotor case 16 and sections through support shafts for screw rotors 26a and 26b. Automatic variable volume ratio valve 12 is integrated into rotor case 16 between male rotor 26a and female rotor 26b. Thus, a portion of rotor case 16 comprises the body of valve 12. Valve 12 includes male-side pressure port 34a, female-side pressure port 34b, male-side auxiliary port 36a, female-side auxiliary port 36b, male-side reed valve 42a and female-side reed valve 42b. Male-side face 44a and female-side face 44b are part of male and female screw rotor bores 30, and discharge end face 46 comprises a portion of rotor case 16. Screw rotor bores 30 meet male-side face 44a and female-side face 44b to form bores in which male rotor 26a and female rotor 26b rotate, respectively. Male screw rotor 26a and female screw rotor 26b form compression pocket 48 between rotor lobes 32, screw rotor bores 30 and faces 44a and 44b. For parts of the compression process, either a suction or discharge end wall may also form part of the boundary of the compression pocket, as is discussed with respect to FIGS. 6A-6D.

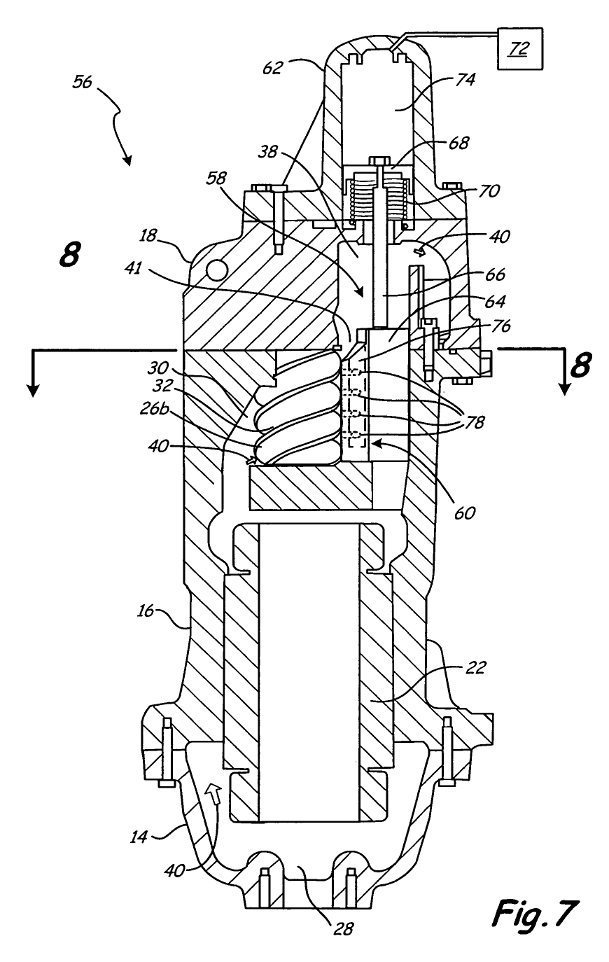

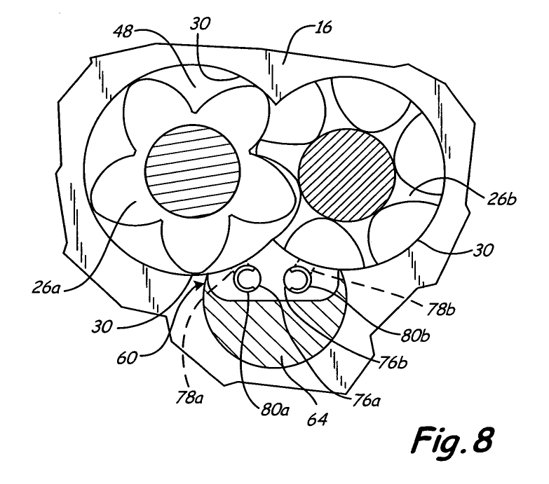

Discharge end face 46 in rotor case 16 forms a discharge port through which fluid exits the compression pocket and enters discharge chamber 38 during the compression process. Valve 12 is formed by machining discharge end face 46, pressure ports 34a and 34b and auxiliary ports 36a and 36b directly into rotor case 16. In other embodiments, as shown in FIGS. 7 and 8, valve 12 can be incorporated into a slide valve that moves within rotor case 16. Male-side and female-side pressure ports 34a and 34b comprise holes bored axially into discharge end face 46 parallel to the major axis of valve 12 and the axes of rotors 26a and 26b. Auxiliary ports 36a and 36b comprise holes bored radially into axial surfaces of valve 12 along faces 44a and 44b, respectively, perpendicular to pressure ports 34a and 34b. Auxiliary ports 36a and 36b provide communication between compression pocket 48 and male and female side pressure bores 34a and 34b, if permitted by deflection of reed valves 42a and 42b. Pressure ports 34a and 34b comprise ducts that outlet to discharge chamber 38 (FIGS. 1 and 2) to provide a shortcut or shunt around the full length of rotors 26a and 26b. Reed valves 42a and 42b are inserted into pressure ports 34a and 34b to meter flow of compressed working fluid from compression pocket 48 to discharge chamber 38. Working fluid from rotors 26a and 26b enters auxiliary ports 36a and 36b as the fluid is pressurized between lobes 32 of screw rotors 26a and 26b. Reed valves 42a and 42b open at a threshold pressure to permit pressurized fluid to escape lobes 32 and enter pressure ports 34a and 34b to flow into discharge chamber 38. The geometry of valve 12, as well as the number and position of bores 34a and 34b and bores 36a and 36b can be varied to provide additional control over the flow of refrigerant through valve 12.

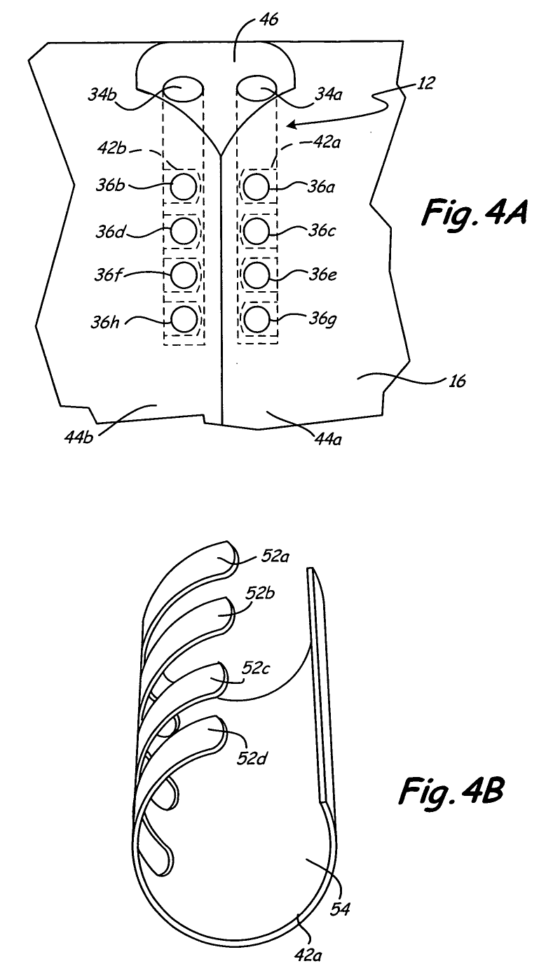

FIG. 4A is a top view of a portion of rotor case 16 showing automatic variable volume ratio valve 12 of FIGS. 2 and 3. Valve 12 includes male-side pressure port 34a, female-side pressure port 34b, male-side auxiliary ports 36a, 36c, 36e and 36g, female-side auxiliary ports 36b, 36d, 36f and 36h, male-side reed valve 42a, female-side reed valve 42b, male-side face 44a, female-side face 44b and discharge end face 46. In the embodiment shown, faces 44a and 44b are each provided with four radial ports. In other embodiments, fewer or greater numbers of radial ports may be used.

Pressure ports 34a and 34b comprise blind-end bores that extend into discharge end face 46 such that refrigerant is not permitted to pass axially through valve 12 or rotor case 16. Radial auxiliary ports 36a-36h extend into faces 44a and 44b, respectively, only so far as to intersect pressure ports 34a and 34b. Pressure ports 34a and 34b are preferably positioned relative to faces 44a and 44b so as to minimize the volumes of fluid trapped in auxiliary ports 36a-36h between faces 44a and 44b and reed valves 42a and 42b. It is desirable to minimize the trapped volumes to minimize deleterious effects on compressor efficiency. Specifically, fluid or gas trapped within these volumes escapes compression within compression pocket 48 as lobes 32 pass over them. Thus, pressure ports 34a and 34b are positioned close to faces 44a and 44b to minimize the volume of ports 36a-36h. Reed valves 42a and 42b, visible in phantom, are inserted into and secured in each of pressure ports 34a and 34b.

FIG. 4B is a perspective view of multi-fingered reed valve 42a for use in automatic variable volume ratio valve 12 of FIG. 4A. Reed valve 42b is identical to reed valve 42a, differing only in orientation when assembled with valve 12. Reed valve 42a, as shown in FIG. 4B, includes reed valve fingers 52a-52d and reed valve root member 54. Reed valve root member 54 comprises a single, continuous body that connects with each individual reed valve finger 52a-52d. Reed valve 42a is aligned and sized such that each individual reed finger completely covers a single radial auxiliary port 36a, 36c, 36e and 36g when the valve is inserted into pressure port 34a. For valve 12 shown in FIG. 4A, reed valve finger 52a covers radial 36g, reed valve finger 52b covers auxiliary port 36e, and so on. Reed valve fingers 52a-52d are capable of undergoing repetitive loading cycles in bending. Reed valve 42a is cylindrically configured so as to match the circumference and shape of pressure port 34a when installed as shown on FIG. 3.

In practice, to avoid a loose fit for any assemblies that might result from slight variations in manufactured size in port 34a and reed valve 42a, the nominal cross-section size of reed valve 42a prior to assembly with port 34a may be slightly larger than the nominal diameter of port 34a to provide slight interference for most assemblies. The amount of interference is chosen in combination with parameters that affect the stiffness of reed valve fingers 52a-52d to minimize any deleterious impact on the intended function. For example, valve fingers 52a-52d are configured to have stiffnesses such that fingers 52a-52d can be deflected by pressures generated within compressor 10.

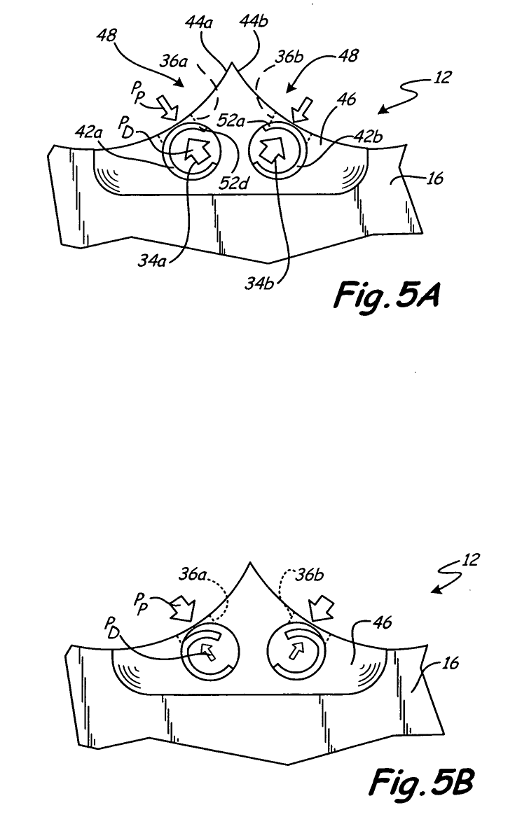

FIGS. 5A and 5B show axial end views of discharge end face 46 in rotor case 16 that illustrate the pressure differentials within compressor 10 that automatically operate reed valves 42a and 42b. Valve 12 is formed in rotor case 16 of compressor 10 between rotors 26a and 26b (FIG. 3) such that compression pocket 48 asserts pocket pressure P_{P} against faces 44a and 44b, and discharge chamber exerts discharge pressure P_{D} against discharge end face 46. Compression pocket pressure P_{P} extends through auxiliary ports 36a and 36b to act on outer surfaces of fingers 52d and 52a of reed valves 42a and 42b. Discharge chamber pressure P_{D} extends through pressure ports 34a and 34b to act on inner surfaces of fingers 52d and 52a of reed valves 42a and 42b. If compression pocket pressure P_{P} is less than discharge chamber pressure P_{D}, then the discharge chamber pressure maintains the fingers pressed against the walls of pressure ports 34a and 34b. Thus, compression pocket 48 remains sealed and working fluid continues to flow across faces 44a and 44b. If discharge pressure P_{D} is less than compression pocket pressure P_{P}, then the pocket pressure forces the fingers away from the walls of pressure ports 34a and 34b. Thus, the seal of compression pocket 48 is broken and working fluid is permitted to travel through pressure ports 34a and 34b to reach discharge chamber 38, after being partially compressed. As discharge pressure P_{D} changes under different operating conditions of compressor 10, the position along valve 12 at which pocket pressure P_{P} equals discharge pressure P_{D} also changes. Thus, different fingers of reed valves 42a and 42b will deflect, as is illustrated in FIGS. 6A-6D.

FIGS. 6A-6D illustrate a compression cycle and the method by which valve 12 automatically varies screw compressor volume ratio. FIGS. 6A-6D show portions of rotor bores 30 with successive compression pockets between screw rotor lobes 32 superposed. Valve 12 is shown in hidden lines beneath rotors 26a and 26b. Screw rotors 26a and 26b are positioned between end walls 55a, 55b and 55c, which assist in forming compression pocket 48 for portions of the compression process. For example, end walls 55a and 55b form a discharge port that regulates how long compression pocket 48 remains sealed, and end wall 55c comprises an end face seal that seals compression pocket 48 at the beginning of the compression process. Valve 12 is positioned between rotors 26a and 26b such that pressure ports 34a and 34b open to discharge port 41. Auxiliary ports 36a-36h, which are also shown in hidden lines, extend from pressure ports 34a and 34b and open through faces 44a and 44b to rotors 26a and 26b (FIG. 3), respectively. In FIG. 6A, the shaded area represents compression pocket 48 after having just been sealed by rotation of rotors 26a and 26b. The initial volume of compression pocket 48 is designated as V_{b} and the initial pressure within pocket 48 is designated P_{b}. As discussed in greater detail below with respect to FIGS. 6B-6D, rotors 26a and 26b rotate to translate compression pocket 48 towards discharge port 41, decreasing volume V_{b} and causing a corresponding increase in pressure P_{b}.

A conventional compressor would continue to compress the working fluid until compression pocket 48 comes into communication with discharge chamber 38, as shown in FIG. 6D, without, however, passing compression pocket 48 over valve 12 or auxiliary ports 36a-36h. The shaded area represents the compression pocket volume at the moment it communicates with discharge port 41. This volume is designated as V_{f}. The volume ratio (Vᵢ) is then V_{b}/V_{f}. If compression pocket pressure P_{f} of volume V_{f} is equal to discharge chamber pressure P_{D}, no over or under compression occurs and the compressor is operating at peak efficiency. Discharge chamber pressure P_{D}, however, often does not remain constant due to changes in system operating conditions. Therefore, mismatches between final compression pocket pressure P_{f} and discharge chamber pressure P_{D} typically occur. Valve 12 of the present invention provides a means for balancing final compression pocket pressure P_{f} and discharge chamber pressure P_{D} to facilitate operation of compressor 10 at peak efficiency.

FIG. 6B shows an intermediate stage of compression in which compression pocket 48 translates toward discharge port 41. The volume of compression pocket 48 is reduced to intermediate volume V₂, which is less than V_{b} but greater than V_{f}. The pressure of compression pocket 48 rises to intermediate pressure P₂, which is greater than P_{b} due to compression. In FIG. 6B, compression pocket 48 has translated far enough along the axis of rotors 26a and 26b to contact auxiliary ports 36h and 36g. At this point, the volume ratio is V_{b}/V₂.

FIG. 6C shows compression pocket 48 progressing further towards discharge port 41. Compression pocket 48, now at volume V₃ and with pressure P₃, which is greater than P₂ due to further compression, is in contact with subsequent auxiliary ports 36c-36f. If pressure P₃ is greater than discharge pressure P_{D}, as is determined by the operating conditions of compressor 10, fingers of reed valves 42a and 42b within pressure ports 34a and 34b will deflect, similar to those illustrated in FIG. 5B. Reed valve fingers 52b and 52c (FIG. 4B) of valves 42a and 42b are deflected inward under the forces caused by the pressure differential between P₃ and P_{D}, allowing some working fluid to exit compression pocket 48 by entering pressure ports 34a and 34b and then pass to discharge port 41. As a result of this escape of fluid from compression pocket 48, pocket pressure P_{P} of compression pocket 48 will not substantially exceed discharge pressure P_{D} so long as auxiliary ports 36 are sized large enough to not substantially restrict the flow rate of escaping fluid.

As compression pocket 48 progresses towards discharge chamber 38, the pressure within pocket 48 continues to build such that the action of successive auxiliary ports 36a and 36b and reed valve fingers 52a will be similar to that just described. Thus, fluid continues to discharge through pressure ports 34a and 34b at pressures not substantially exceeding discharge pressure P_{D}. As a result, when compression pocket 48 finally connects with discharge port 41 as shown in FIG. 6D, compression pocket pressure P_{P} will not substantially exceed discharge pressure P_{D} and refrigerant will also pass through port 41 at a pressure near P_{D}.

At almost any point during the compression cycle, working fluid can escape compression pocket 48 if compression pocket pressure P_{P} exceeds discharge chamber pressure P_{D}. In this manner, the rotary screw compressor automatically varies Vᵢ so as to discharge working fluid at a pressure closely matched to discharge chamber pressure. The specific point along valve 12 at which pocket pressure P_{P} exceeds discharge pressure P_{D} depends on the operating conditions of compressor 10. The embodiments shown have depicted multi-fingered reed valves with four fingers and corresponding radial ports for exemplary purposes. In other embodiments, one, two, three or even more than four fingers may be used, depending on the compressor in which it is intended to be used and the intended application of such compressor.

The automatic volume ratio variation means described herein acts only under conditions of over-compression, when compression pocket 48 pressure P_{P} exceeds discharge pressure P_{D}. It may be useful for reducing occurrences of under-compression, when compression pocket 48 reaches discharge chamber 38 before pocket pressure P_{P} reaches discharge chamber pressure P_{D}. For example, valve 12 can be used in combination with means for setting, e.g. increasing, the built-in or base V, of compressor 12, such as end walls 55a and 55b, slide valves, or other means to delay discharge of compressed fluid from the rotors as are known in the art. As such, the compression pocket pressure P_{P} will then reach the level of discharge pressure P_{D} before compression pocket 48 is connected to discharge chamber 38 for a greater portion of the operating conditions it is subjected to. As a result, the automatic volume ratio variation means described herein, such as valve 12, will be activated for a greater portion of the operating conditions and provide its intended benefit.

Other aspects of the present invention may also be varied to enhance the capability of valve 12 to match pocket pressure P_{P} with discharge pressure P_{D}. For example, the embodiments shown have depicted reed valves on both male rotor side and female side of cusp for exemplary purposes. In other embodiments of the invention, however, placement of a single reed valve on only the male-side or only the female-side may offer acceptable automatic Vᵢ variation at lower cost in compressors designed for some applications. Also, the embodiments shown have depicted uniformly spaced reed fingers and corresponding uniformly spaced radial ports. In other embodiments of the invention, however, non-uniformly spaced reed fingers and radial ports may be used for some applications. In other embodiments of the invention, the automatically variable Vᵢ system may also be incorporated into compressors having a capacity control slide valve, as is shown in FIGS. 7-8.

FIG. 7 is a side sectional view of screw compressor 56 having a slide valve 58 including an automatic variable volume ratio valve 60 of the present invention. Compressor 56 includes components similar to those of compressor 10 of FIG. 1-FIG. 3, with like components labeled accordingly. For example, compressor 56 includes motor case 14, rotor case 16, outlet case 18, motor stator 22, female screw rotor 26b, intake port 28, rotor bores 30, lobes 32 and discharge chamber 38. Rotor shaft 20, motor rotor 24 and male screw rotor 26a are omitted for clarity. Compressor 56 also includes slide case 62 in which slide valve 58 reciprocates. Slide valve 58 (which is not shown in cross section for clarity) includes valve body 64, in which valve 60 is placed, piston rod 66, piston head 68 and biasing spring 70. Slide valve 58 operates as is known in the art to vary the capacity of compressor 56. Specifically, actuation means 72 directs a hydraulic fluid into piston chamber 74 to adjust the axial position of piston head 68, which through piston rod 66 adjusts the axial position of valve body 64 relative to male and female rotors 26a and 26b. As such, the length along which valve body 64 engages lobes 32 varies to adjust the amount of fluid compressed between rotors 26a and 26b and rotor bores 30. Valve body 64 includes pressure port 76 and radial ports 78 similar to that of valve 12 of FIGS. 2-6D.

FIG. 8 is a front sectional view of screw compressor 56 of FIG. 7 showing a front surface of rotor case 16 and sections through slide valve 58 and support shafts for screw rotors 26a and 26b. Slide valve 58 includes automatic variable volume ratio valve 60 and is positioned between screw rotors 26a and 26b. Valve body 64 comprises arcuate pressure surfaces to mate with screw rotors 26a and 26b. Valve body 64 also includes a partially cylindrical bottom side for sliding along rotor housing 16 when actuated by piston rod 66 and piston head 68. Valve 60 includes pressure ports 76a and 76b, which comprise axial bores that extend discharge chamber 38 into valve 60. Auxiliary ports 78a and 78b extend radially into the arcuate pressure surfaces to connect pressure pocket 48 with pressure ports 76a and 76b. Reed valves 80a and 80b are inserted into pressure ports 76a and 76b to seal pressure ports 76a and 76b from auxiliary ports 78a and 78b. Reed valves 80a and 80b permit fluid from pressure pocket 48 to escape to discharge chamber 38 when pressure inside pressure pocket 48 exceeds pressure within discharge chamber 38.

In any embodiment of the invention, a valve is provided for automatically varying compressor volume ratio in a rotary screw compressor, closely matching final compression pocket pressure to system discharge pressure without using electronic feedback control. At least one axial pressure port is positioned in a screw rotor housing or into a slide valve body so that the pressure port is adjacent a pressure pocket between screw rotors. The pressure port communicates the pressure pocket with system discharge pressure. A radial auxiliary port, or a series of auxiliary ports, extends from a portion of the screw rotor housing in contact with the compression pocket to the pressure port. A reed valve having a reed finger for each auxiliary port is inserted into each pressure port. The reed valve is cylindrically configured, sized and positioned such that the reed valve fits securely in the pressure port and individual reed fingers completely cover individual radial auxiliary ports.

As the compression pocket travels down the axial length of the screw rotors, it sequentially contacts the radial auxiliary ports. As the compression pocket passes over a radial auxiliary port, compression pocket pressure within the auxiliary port acts on the topside of the reed valve finger covering the auxiliary port, while discharge pressure acts on the finger's underside within the pressure port. If the compression pocket pressure is greater than discharge pressure, the reed finger deflects, allowing working fluid to pass out of the compression pocket. Working fluid then flows through the axial pressure port into a discharge chamber of the compressor. The number and location of both radial ports and axial ports can be altered to match a variety of operating conditions. In this manner, the screw compressor is able to automatically vary the volume ratio so as to nearly match pocket pressure at the time of fluid exit more closely to discharge pressure.

The combination of radial auxiliary ports and axial pressure ports having fitted reed valves is sufficient to largely prevent over-compression. Under-compression may be prevented over a wide range of operating conditions by configuring the screw compressor system to have a relatively high built in Vᵢ such that fluid rarely reaches the discharge port under-compressed.

Although the present invention has been described with reference to preferred embodiments, workers skilled in the art will recognize that changes may be made in form and detail without departing from the spirit and scope of the invention.

What is claimed is:

1. A valve for varying volume ratio in a screw compressor to balance a compression pocket pressure and a discharge pressure in the screw compressor, the valve comprising:
a valve body defining a duct and an auxiliary port;
the duct including an open end in communication with a discharge chamber of the compressor and thereby the discharge pressure;
the auxiliary port extends from a rotor bore of the compressor to the duct and provides fluid communication therebetween for communicating the compression pocket pressure to the duct; and
a reed valve disposed in the duct for regulating fluid flow between the compression pocket and the duct, the reed valve being operable via a pressure differential between the compression pocket pressure and the discharge pressure.

2. The valve of claim 1 wherein the duct is positioned so as to minimize a volume of the auxiliary port.

3. The valve of claim 1 wherein the duct includes a blind-end bore extending generally parallel with a length of the rotor bore.

4. The valve of claim 3 wherein the auxiliary port extends generally radially from the duct.

5. The valve of claim 3 wherein the valve body further defines a plurality of auxiliary ports extending along a length of the duct for communicating with the compression pocket throughout a compression cycle of the compressor.

6. The valve of claim 5 wherein the reed valve includes a plurality of fingers, each finger corresponding to one of the plurality of auxiliary ports.

7. The valve of claim 1 wherein the reed valve opens if the compression pocket pressure is greater than the discharge pressure allowing a working fluid to flow from the compression pocket to the discharge chamber through the reed valve.

8. The valve of claim 1 wherein the reed valve is held in a closed position if the discharge pressure is greater than the compression pocket pressure thereby preventing a working fluid from flowing from the compression pocket to the discharge chamber.

9. The valve of claim 1 wherein the valve body further comprises a duct, an auxiliary port and a reed valve corresponding to each of a male rotor and a female rotor of the screw compressor.

10. The valve of claim 1 wherein the valve body is incorporated into a slide valve of the compressor, the slide valve forming a portion of the rotor bore and being movable axially relative to a rotor of the compressor to vary capacity of the screw compressor.

11. A screw compressor having a valve for varying a volume ratio of the screw compressor, the screw compressor comprising:
a compressor housing comprising:
a screw rotor bore;
a suction port in fluid communication with a first end of the rotor bore; and
a discharge chamber in fluid communication with a second end of the rotor bore, the discharge chamber having a discharge chamber pressure;
intermeshing male and female screw rotors disposed within the screw rotor bore, the intermeshing male and female screw rotors having lobes defining a compression pocket with the rotor bore, the compression pocket having a compression pocket pressure; and
a valve body disposed along the screw rotor bore between the intermeshing male and female screw rotors, the valve body comprising:
a duct extending into the valve body and including an open end thereof in fluid communication with the discharge chamber and the discharge chamber pressure;
an auxiliary port extending from the rotor bore to the duct and providing fluid communication therebetween for communicating the compression pocket pressure to the duct; and
a reed valve disposed in the duct for regulating fluid flow between the compression pocket and the duct, the reed valve being operable via a pressure differential between the compression pocket pressure and the discharge chamber pressure.

12. The screw compressor of claim 11 wherein the duct is positioned so as to minimize a volume of the auxiliary port.

13. The screw compressor of claim 11 wherein the duct includes a blind-end bore extending generally parallel with a length of the screw rotor bore.

14. The screw compressor of claim 13 wherein the auxiliary port extends generally radially from the duct.

15. The screw compressor of claim 13 wherein the valve body further defines a plurality of auxiliary ports extending along a length of the duct for communicating with the compression pocket throughout a compression cycle of the compressor.

16. The screw compressor of claim 15 wherein the reed valve includes a plurality of fingers, each finger corresponding to one of the plurality of auxiliary ports.

17. The screw compressor of claim 11 wherein the reed valve opens if the compression pocket pressure is greater than the discharge chamber pressure allowing a working fluid to flow from the compression pocket to the discharge chamber through the reed valve.

18. The screw compressor of claim 11 wherein the reed valve is held in a closed position if the discharge chamber pressure is greater than the compression pocket pressure thereby preventing a working fluid from flowing from the compression pocket to the discharge chamber.

19. The screw compressor of claim 11 wherein the valve body further comprises a duct, an auxiliary port and a reed valve corresponding to each of the intermeshing male and female screw rotors.

20. The screw compressor of claim 11 wherein the valve body is incorporated into a slide valve of the compressor, the slide valve forming a portion of the screw rotor bore and being movable axially relative to the intermeshing male and female screw rotors to vary capacity of the screw compressor.

21. The screw compressor of claim 11 wherein the discharge chamber includes restrictor plates to set the base volume ratio of the screw compressor.
